(19) United States
(12) Patent Application Publication
(10) Pub. No.: US 2013/0166759 A1
(43) Pub. Date: Jun. 27, 2013

(54) APPARATUS, SYSTEMS, AND METHODS OF IP ADDRESS DISCOVERY FOR TUNNELED DIRECT LINK SETUP

(71) Applicants: Krishnan Rajamani, San Diego, CA (US); Maarten Menzo Wentink, Breukelen (NL)

(72) Inventors: Krishnan Rajamani, San Diego, CA (US); Maarten Menzo Wentink, Breukelen (NL)

(73) Assignee: QUALCOMM INCORPORATED, San Diego, CA (US)

(21) Appl. No.: 13/334,240

(22) Filed: Dec. 22, 2011

(51) Int. Cl. G06F 15/16

(52) U.S. Cl. 709/227

(57) ABSTRACT

A method of peer discovery in a communications network includes transmitting, by a first client station, a request to a second client station; receiving a response of the second client station, at least one of the request and the response including a local IP address of the corresponding client station; and establishing a tunneled direct link setup (TDLS)direct link between the first client station and the second client station based on the local IP address.

### BACKGROUND

1. Field

This disclosure relates generally to wireless communication network apparatus, systems, and methods, and more particularly, the disclosure relates to device discovery in WLAN systems based on the IEEE 802.11 protocol (WiFi).

2. Background

In many telecommunication systems, communications networks are used to exchange messages among several interacting spatially separated devices. The various types of networks may be classified in different aspects. In one example, the geographic scope of the network could be over a wide area, a metropolitan area, a local area, or a personal area, and the corresponding networks would be designated as wide area network (WAN), metropolitan area network (MAN), local area network (LAN), or personal area network (PAN). Networks also differ in the switching/routing technique used to interconnect the various network nodes and devices (e.g., circuit switching vs. packet switching), in the type of physical media employed for transmission (e.g., wired vs. wireless), or in the set of communication protocols used (e.g., Internet protocol suite, SONET (Synchronous Optical Networking), Ethernet, etc.).

One important characteristic of communications networks is the choice of wired or wireless media for the transmission of electrical signals among the constituents of the network. In the case of wired networks, tangible physical media such as copper wire, coaxial cable, fiber optic cable, etc. are employed to propagate guided electromagnetic wave-forms that carry message traffic over a distance. Wired networks are a static form of communications networks and are typically favored for interconnection of fixed network elements or for bulk data transfer. For example, fiber optic cables are often the preferred transmission media for very high throughput transport applications over long distances between large network hubs, such as, hulk data transport across or between continents over the Earth's surface.

On the other hand, wireless networks are often preferred when the network elements are mobile with dynamic connectivity needs or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks have the distinct advantage of facilitating user mobility and rapid field deployment compared to fixed wired networks. However, usage of wireless propagation requires significant active resource Management among the network users and higher levels of mutual coordination and cooperation for compatible spectrum utilization.

### BRIEF DESCRIPTION OF THE DRAWINGS

FIG. 1 is a schematic diagram of a wireless communication network system in accordance with various embodiments of the disclosure.

FIG. 2 is a block diagram of a probe request that may be used in a wireless communication network system in accordance with various embodiments of the disclosure.

FIG. 3 is a block diagram of a probe response that may be used in a wireless communication network system in accordance with various embodiments of the disclosure.

FIG. 4 is a block diagram of a format of a base station set identifier (BSSID) element used in a wireless communication network system in accordance with various embodiments of the disclosure.

FIG. 5 is a block diagram of an Association Element used in a wireless communication network system in accordance with various embodiments of the disclosure.

FIG. 6 is a block diagram of an encapsulated discovery request that may be used in a wireless communication network system in accordance with various embodiments of the disclosure.

FIG. 7 is a block diagram of an encapsulated discovery response that may be used in a wireless communication network system in accordance with various embodiments of the disclosure.

FIG. 8 is table of elements of a format of a TDLS discovery request frame with a Basic Service Set Identifier (BSSID) element that may be used in a wireless communication network system in accordance with various embodiments of the disclosure.

FIG. 9 is table of elements of a format of a TDLS discovery response frame with a Basic Service Set Identifier (BSSID) element that may be used in a wireless communication network system in accordance with various embodiments of the disclosure.

FIG. 10 is a block diagram of an Association Element that may be used in a wireless communication network system in accordance with various embodiments of the disclosure.

FIG. 11 is schematic diagram of a station (STA) for performing Tunneled Direct Link Setup (TDLS) discovery in a wireless communication network in accordance with various embodiments of the disclosure.

FIG. 12 is a method in accordance with various embodiments of the disclosure.

### DETAILED DESCRIPTION

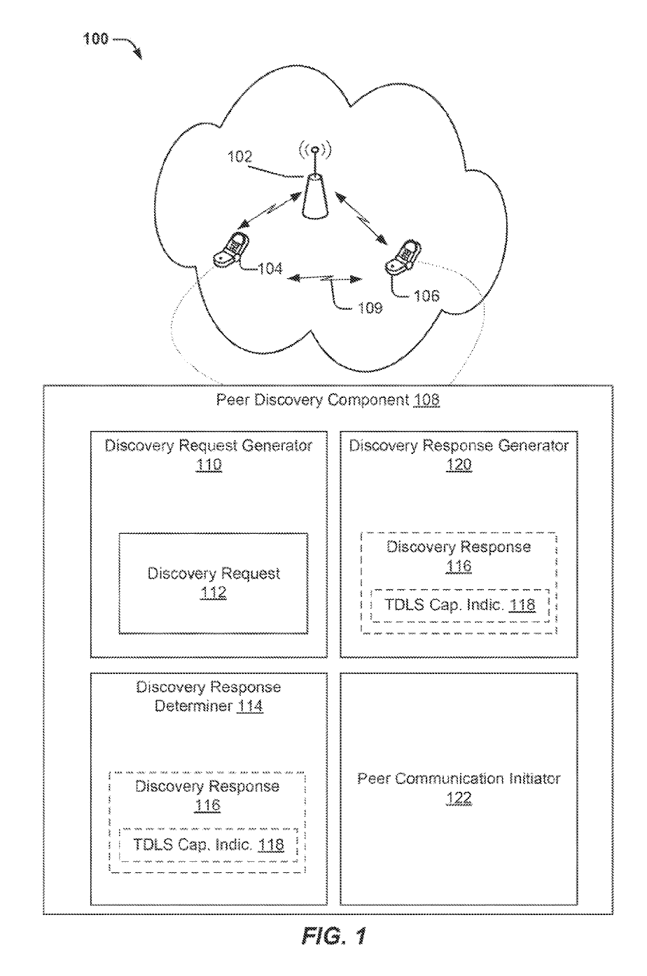

Referring to FIG. 1, in one example, popular wireless network technologies include various types of wireless local area networks (WLANs). A WLAN 100 may be used to interconnect nearby devices together, employing widely used networking protocols such as WiFi or, more generally, a member of the IEEE 802.11 wireless protocol family.

In some embodiments, a WLAN 100 is comprised of various stations (STA), which are the components that access the wireless network. In one example, there are two types of stations (STAs): access points 102 and clients 104, 106. In general, an access point serves as a hub or base station for the WLAN and a client serves as a user of the WLAN. For example, a client may be a laptop computer, a personal digital assistant (PDA), a mobile phone, display device, television, monitor, etc. In one example, a client connects to an access point via a WiFi (e.g., IEEE 802.11 protocol) compliant wireless link to obtain general connectivity to the Internet or to other wide area networks.

In some embodiments, 802.11 wireless networks may operate in two modes: infrastructure mode and ad-hoc mode. In infrastructure mode, a client or station (STA) connects to an access point (AP), which serves as a hub for connecting with other wireless clients to the network infrastructure, including, for example, Internet access. Infrastructure mode uses a client-server architecture to provide connectivity to the other wireless clients. In ad-hoc mode, wireless clients have direct connections to each other in a peer-to-peer architecture. In some embodiments, 802.11 wireless networks generate a periodic Beacon signal, which broadcasts wireless network characteristics (e.g., maximum data rate, encryption status, AP MAC address, SSID, etc.) to all nearby clients. For example, the SSID identifies a particular wireless network.

In some embodiments, the wireless protocol IEEE 802.11z defines a protocol that allows wireless 802.11 stations (STAs) that are associated with the same Access Point (AP) to set up a direct link, e.g., a wireless peer-to-peer connection, between them. The protocol is referred to as Tunneled Direct Link Setup (TDLS). The TDLS setup messages are encapsulated in a specific Ethertype, so that they can be tunneled through any AP. In one example, the Ethertype is a field within an Ethernet frame, which indicates the protocol encapsulated within the frame payload. This is useful in particular because APs do not have to be upgraded for TDLS to be used between two STAs. TDLS direct links can be set up between two TDLS-capable STAs without need to upgrade the AP. Examples of TDLS systems and methods are disclosed in, but are not limited to, U.S. patent application Ser. No. 12/917,382 and U.S. patent application Ser. No. 12/851,358, both of which are herein incorporated by reference in their entirety.

In various embodiments, TDLS assumes that discovery of other STAs in the same Basic Service Set (BSS) (e.g., associated with the same AP) is based on detecting source and destination addresses and sending a TDLS setup request without prior knowledge of the intended peer STA's capabilities. In various embodiments, a list of potential peer STAs that are TDLS capable can be available before attempting a TDLS direct link setup.

In some embodiments, a peer discovery component 108 is included at one or more stations, such as at the clients 104 and 106, to manage discovery of, and communication with, one or more other peer STAs. In some embodiments, for example, the peer discovery component 108 may be one or any combination of hardware, software, firmware, executable instructions, or data, executable to facilitate discovery of one or more peer STAs and initiate and/or establish setup of a TDLS direct link 109. In some embodiments, peer discovery component 108 may include a discovery request generator 110 configured to generate a discovery request 112 for information on potential peer STAs. For example, in some embodiments, the discovery request 112 may include a discovery request frame having a particular format, and the discovery request frame may be encapsulated for transparent transmission through another STA, such as the access point 102, as will be discussed in more detail below. Further, for example, in other embodiments, the discovery request 112 may include or be appended to a probe request, or a beacon, transmitted as part of a Peer-to-Peer (P2P) discovery protocol. In this case, for example, the discovery request 112 may include a TDLS capability indication, and optionally may include association information, as will be discussed in more detail below.

Moreover, the peer discovery component 108 may additionally include a discovery response determiner 114 configured to determine if a discovery response 116 has been received. In some embodiments, for example, the discovery response 116 may include, or may provide an inference for determining a TDLS capability indication 118 of one or more peer STAs providing the discovery response 116, e.g., a discovered station or stations. Such a discovered station may be considered a peer device. The TDLS capability indication 118 may be used for identifying a TDLS capable STA, TDLS capabilities of the identified STA, and/or any other parameters for establishing a TDLS communication, e.g., the TDLS direct link 109, with the identified STA.

Additionally, the peer discovery component 108 may additionally include a discovery response generator 120 configured to generate the discovery response 116, such as based upon receipt of the discovery request 112 from another STA. In other words, the STA 106 may operate the discovery response generator 120 to generate the discovery response 116 in reply to receiving the discovery request 112 from the STA 104. Alternatively, or in addition, the STA 104 may operate the discovery response generator 120 to generate a second discovery response in reply to detecting or receiving a second discovery request from another device.

Moreover, the peer discovery component 108 may further include a peer communication initiator 122 to establish communication with another peer STA. For example, in some embodiments, the peer communication initiator 122 includes protocols to initiate or to perform establishment of a TDLS communication with another STA based on the STA information (e.g., TDLS indication) 118 received in the discovery response 116.

For example, in the case of FIG. 1, if the STA 104 transmits the discovery request 112 that is received by the STA 106, then the STA 106 may generate the discovery response 116 and transmit the discovery response 116 for receipt by the STA 104. Based on the TDLS capability indication 118, the STA 104 may then establish the TDLS direct link 109 with the STA 106. Accordingly, in various embodiments, a list of potential peer STAs that are TDLS capable can be available before attempting a TDLS direct link setup.

Discovery refers to a computer protocol that facilitates obtaining access to a wireless device or service. TDLS is defined in the IEEE 802.11z protocol. Peer-to-Peer (P2P) protocol is currently also referred to as Wireless Fidelity (WiFi) Alliance (WFA) Direct. TDLS and P2P may be transport mechanisms for WFA Display (WFD). WFD is a WFA certification label for wireless connections with a display.

Referring to FIGS. 1-3, in some embodiments, the peer discovery component 108 may achieve discovery of potential TDLS peer devices by piggybacking TDLS discovery on P2P device discovery. P2P device discovery is based on a Probe Request/Probe Response exchange between the P2P devices on a so-called social channel. For the purpose of TDLS peer STA discovery performed by the peer discovery component 108, the discovery request 112 and/or the discovery response 116 may include a Probe Request frame 130 and/or a Probe Response frame 132 including the respective TDLS capability indication 119, corresponding to the requesting STA, and/or the TDLS capability indication 118, corresponding to the responding STA.

In some embodiments, the respective TDLS capability indication 118 and/or 119 may be a portion of a capability element 134 or 136, respectively. For example, where the capability element 134 or 136 comprises Extended Capabilities element, the respective TDLS capability indication 118 or 119 may be a bit inside the Extended Capabilities element. Further, for example, the TDLS capability bit may be bit 37 of the Capabilities field of the Extended Capabilities element. In another example, the TDLS capability indication 118 or 119 may not be physically present, but may be inferred from a WFD capability indication 138 or 140 that is included in the Probe Request/Response frame 130/132. In yet another example, the TDLS capability indication 118 or 119 may be inferred from a separate TDLS capability element, e.g., a specific type of the capability element 134 or 136, which may be included in the Probe Request/Response frame 130/132.

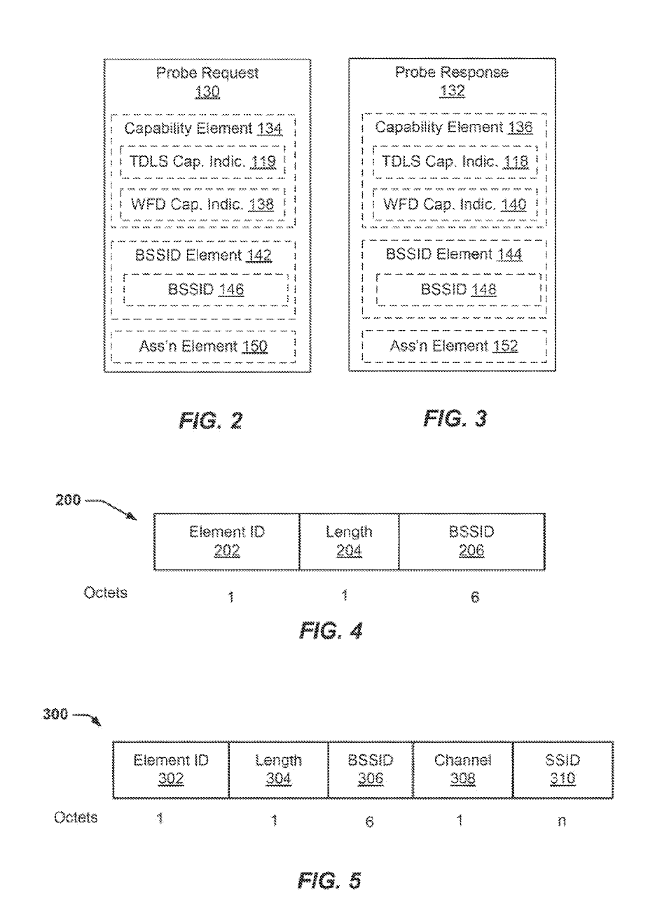

The Peer-to-Peer (P2P) discovery procedure may also yield the Basic Service Set Identifier (BSSID) of an AP with which the TDLS capable device is currently associated. In some embodiments, Basic Service Set in the IEEE 802.11 protocol is comprised of one access point (AP) and all associated stations (STA). The current BSSID 146 or 148, corresponding to the requesting or the responding STA, respectively, may be included in the Probe Request/Response frames 130/132 transmitted as part of P2P discovery, in the form of a BSSID element 142 or 144. Referring to FIG. 4, an example of a BSSID element format 200, such as for BSSID element 142 or 144 of FIGS. 2 and 3, includes the following:

The Element ID field 202 identifies the BSSID element, as defined in Table 7-26 of 802.11-2007 protocol definition.

The Length field 204 is set to 6.

The BSSID field 206 is set to the MAC address of the AP to which the STA is currently associated.

Other information about the current association may be included in the Probe Request/Response 130 or 132 by including an Association Element 150 or 152. The Association Element 150 or 152 may contain information about a current association of the device (e.g., the respective STA) sending the Probe Request/Response frame 130 or 132.

Referring to FIG. 5, an example of an Association Element format 300, such as for association element 150 or 152 of FIGS. 2 and 3, includes the following:

Element ID field 302 identifies the Association element, as defined in Table 7-26 of 802.11-2007 protocol definition.

Channel field 308 is set to the channel of the association.

SSID field 310 is set to the SSID of the association. The Service Set Identifier, SSID, is the human readable name of the network.

With reference to FIGS. 1-5, in some embodiments, a Service Set Identifier specifies a particular 802.11 wireless network, either local or enterprise. Adding a BSSID element 142/144 or an Association element 150/152 to the Probe Request/Response 130/132 may need to be defined at the WiFi Alliance (WFA), for example as part of the WFA TDLS specification, since regular 802.11 STAs do not send Probe Responses, and the Probe Requests are destined only for APs, e.g., the AP 102 (not for other STAs, e.g., the STA 104 or 106). In P2P mode, which is defined entirely within the WFA, STAs sending Probe Requests/Response frames to other STAs are part of the P2P discovery. The TDLS capability bit, e.g., as referred to above with regard to the TDLS capability indication 118 or 119, is to be defined by the Institute of Electrical and Electronics Engineers (IEEE) since the TDLS capability bit requires the definition of a bit inside a field that is controlled by the IEEE.

It should be understood that although the capability element 134 and 136, the BSSID element 142 and 144, and the association element 150 and 152 are described with reference to the probe request 130 and the probe response 132, respectively, these elements may also be present in the discovery request 112 and the discovery response 116. In other words, the discovery request 112 and the discovery response 116 may include one or more of the capability element 134 and 136, the BSSID element 142 and 144, or the association element 150 and 152 in a TDLS discovery process that is not associated with a P2P discovery process.

In one example, if a discovered STA (e.g., the STA 106) indicates that it is currently associated with an AP (e.g., the AP 102) and the scanning STA (e.g., the STA 104) is capable of associating with that AP, the scanning STA may associate with the AP and form a TDLS direct link (e.g., the link 109) with the discovered STA, rather than start a P2P network with the discovered STA. Advantages of forming the TDLS direct link 109 are that concurrent access with the AP is likely to be easier, and there is no need to enter new credentials, in order to connect to the discovered STA (because the credentials for the AP were available at the scanning STA).

In some embodiments, a scanning STA that wants to connect to a discovered STA, which is associated with an AP, has two options. A first option is to start a P2P network with the discovered STA. The P2P network may be started on the same channel as is used for the association with the AP, to simplify concurrent operation by the discovered STA. A second option is that the scanning STA associates to the AP and then sets up a TDLS direct link with the discovered STA. When the scanning STA has credentials for the AP, this process will require no user interaction. When the scanning STA does not have security credentials for the AP, this process will include the user/STA associating with the AP, either by entering the security credentials, or by push-button configuration, etc. One skilled in the art would understand that many techniques for establishing security credentials can be used without affecting the spirit or scope of the present disclosure.

In other embodiments, if the scanning STA is currently associated with the same AP as the discovered STA, the scanning STA may be able to communicate through the AP (since most APs allow their associated STAs to communicate peer-to-peer). In some embodiments, whether direct STA-to-STA communication is possible can be tested by sending a TDLS discovery frame (e.g., the discovery request 112) to the discovered STA, through the AP. For example, the discovered STA sends a TDLS discovery response (e.g., the discovery response 116) when the discovered STA receives the discovery request. In one example, the peer discovery component 108 of the scanning STA may maintain a timer corresponding to the transmission of the discovery request 112, and when a response timeout occurs (e.g., when the timer expires) the scanning STA assumes that STA-to-STA communications are blocked by the AP. In other embodiments, the type of security of the link 109 between the STA and the AP may be indicated in the Association Element (e.g., in the association element 150 or 152.

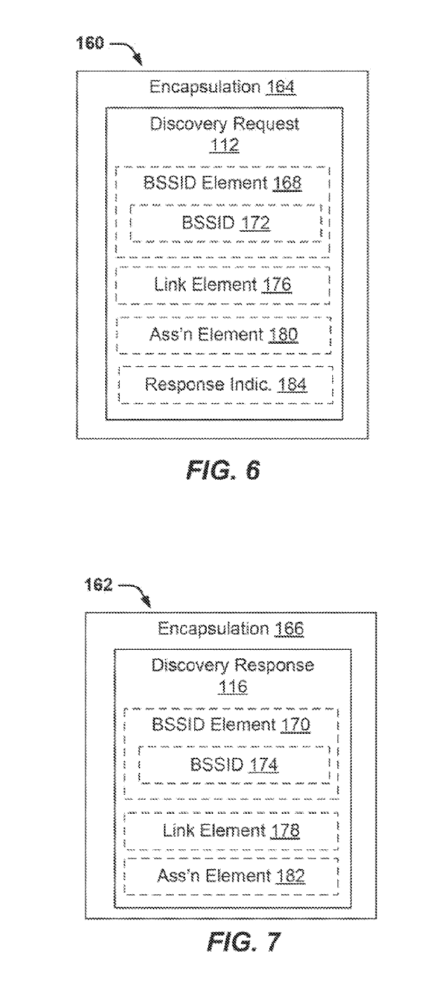

Referring to FIGS. 1-7, in some embodiments, the peer discovery component 108 may be configured to generate and transmit an encapsulated discovery request 160 and/or an encapsulated discovery response 162. For example, the encapsulated discovery request 160 and the encapsulated discovery response 162 correspond to the discovery request 112 and the discovery response 116, respectively, each contained within an encapsulation 164 and 166, respectively. For example, in some embodiments, the encapsulation 164 and 166 may be a message or frame format that allows the discovery request 112 and the discovery response 116 to be transparently transmitted through another STA (e.g., the AP 102). For instance, the encapsulation 164 and 166 may include, but is not limited to a layer 2 (L2) encapsulation. Accordingly, the encapsulated discovery request 160 and the encapsulated discovery response 162 define two new TDLS frames for the purpose of TDLS discovery.

In some embodiments, the encapsulated TDLS discovery request/response frames 160 and 162 may include at least a respective Basic Service Set Identifier (BSSID) element 168 and 170, which identifies a respective BSSID 172 and 174 of the Media Access Control (MAC) address of the AP to which the STA sending the TDLS discovery request frame 160 or discovery response frame 162 is associated. It is noted that the BSSID element 168 and 170 may have the same format as the BSSID element format 200 and/or may be the same as the BSSID elements 142 and 144, respectively.

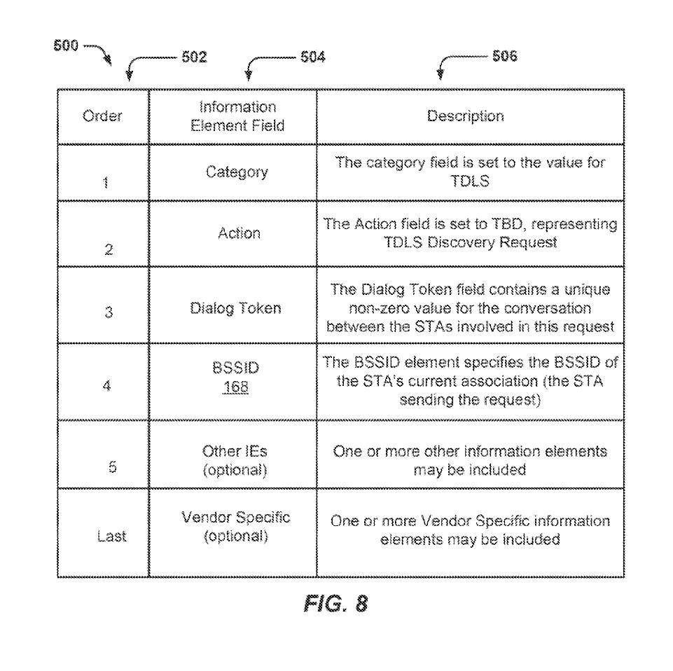

FIG. 8 illustrates an example of encapsulated TDLS discovery request frame format 500. With reference to FIGS. 1-8, the TDLS discovery request frame format 500 may be used for the encapsulated TDLS discovery request frame 160, including the Basic Service Set Identifier (BSSID) element 168. Further, the encapsulated TDLS discovery request frame format 500 may include various other information elements 504, as described at 506, and which may be ordered as indicated at 502.

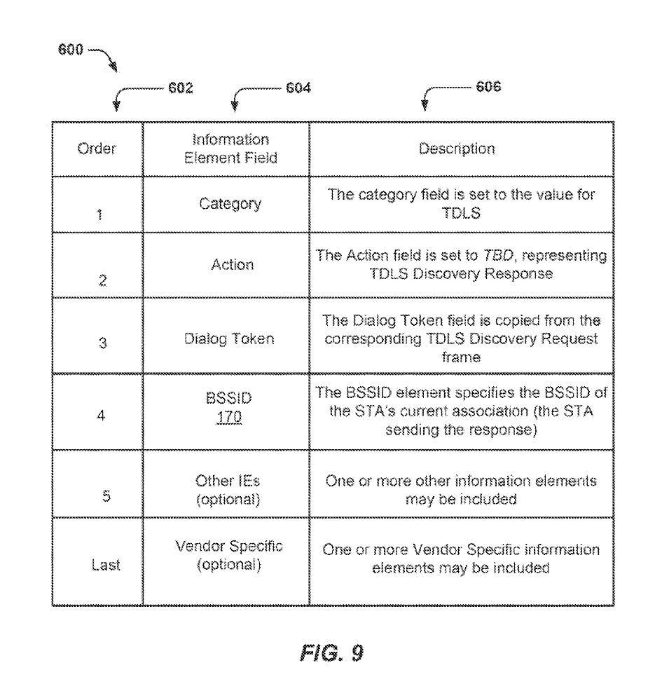

FIG. 9 illustrates an example TDLS discovery response frame format 600. With reference to FIGS. 1-9, the TDLS discovery response frame format 600 may be used for the encapsulated TDLS discovery response frame 162, including the Basic Service Set Identifier (BSSID) element 170. Further, the encapsulated TDLS discovery response frame format 600 may include various other information elements 604, as described at 606, and which may be ordered as indicated at 602.

In various embodiments, instead of the respective BSSID elements 168 and 170, the existing Link Identifier element 176 and 178 as defined in 802.11z may be respectively included in the encapsulated TDLS discovery request and response frames 160 and 162. Examples of formats for such frames and other types of frames are disclosed in, but are not limited to, U.S. patent application Ser. No. 12/917,382, which is herein incorporated by reference in its entirety.

In some embodiments, the encapsulated discovery request frame 160 and the encapsulated discovery response frame 162 each may include a respective association element 180 and 182, which includes other information regarding a current association of the respective STA. For example, the association element 180 and 182 may include information such as, but not limited to, the type of security (e.g., security type) on the link with the AP, the operating channel, the operating channel bandwidth, the current PHY rate from the AP, the current PHY rate to the AP, etc. It is noted that the association element 180 and 182 may be the same as, or similar to, the association element 150 and 152.

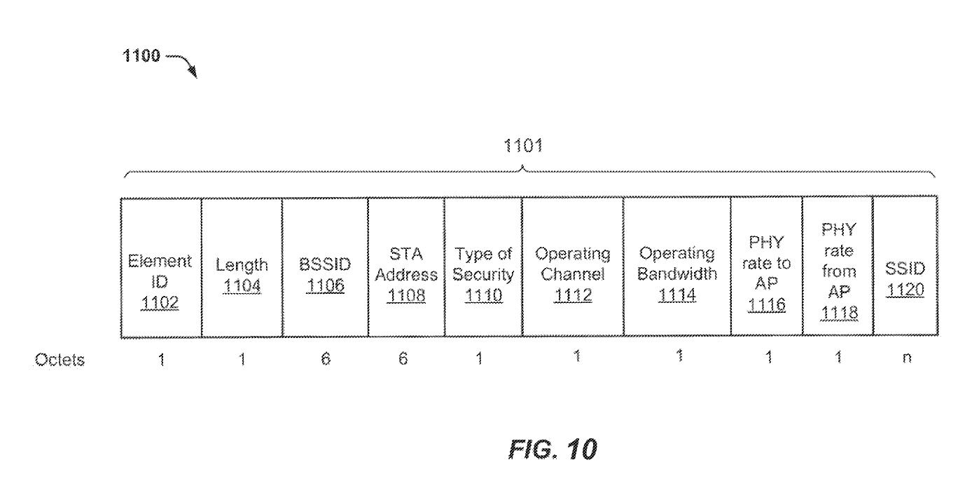

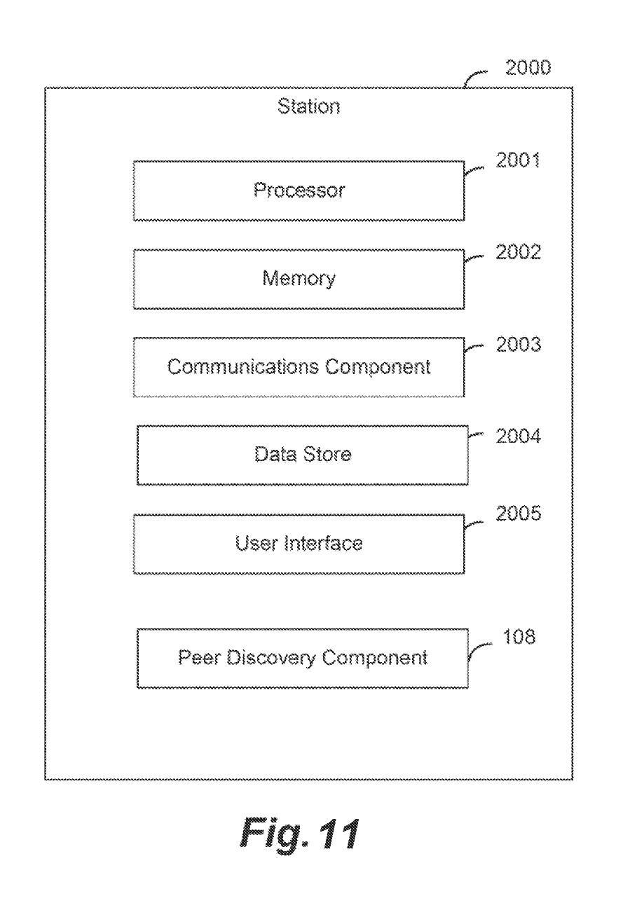

FIG. 10 illustrates an example of an Association Element format 1100, which contains information about the current association of a device. With reference to FIGS. 1-10, for example, association element format 1100 may include one or more information elements 1101 including, but not limited to, one or more of an element ID field 1102, a length field 1104, a BSSID field 1106 (which may be the same as or similar to the previously discussed BSSID fields), an STA address field 1108, a type of security field 1110, an operating channel field 1112, an operating bandwidth field 1114, a PHY rate to AP field 1116, a PHY rate from AP field 1118, and an SSID field 1129.

In some embodiments, the information elements 1101 that are related to device type discovery or service discovery (including vendor specific elements) are 110504 11 added to the discovery frames. The TDLS discovery request/response frames 160 and 162 may include some or all of the information elements 1101 that would typically be included in a Probe Request/Response frame as transmitted by a STA. In particular embodiments, STAs only transmit Probe Response frames when they operate as a P2P device.

In some embodiments, the TDLS discovery request frame 160 is transmitted to a broadcast address, so that any device in the network layer 2 domain can receive it. Devices in the same network layer 2 domain could be devices associated with the AP, but also devices connected through the wired interface of the AP and wireless devices that are associated with another AP.

In some embodiments, STAs that receive a TDLS discovery request frame 160 and are TDLS capable may respond with the TDLS discovery response frame 162. A TDLS discovery response frame 162 may not be transmitted when the BSSID 172 (or, another BSSID value from one of the other elements that may be included in discovery request 160) indicated in the TDLS discovery request frame 160 does not match its own BSSID 174 (or, another BSSID value from one of the other elements that associated with the discovery response 160 or the responding STA). The 802.11z protocol currently does not allow a TDLS direct link 109 to be set up between STAs that are associated with different BSSIDs. Thus, in such embodiments, the TDLS discovery request 160 may include an indication 184 of whether a response should be sent or not in case of a non-matching BSSID.

In other embodiments, the channel 1012 of the current association is included in the TDLS discovery request/response 160 or 162. When the channels are the same, this indicates that the STAs can set up a TDLS direct link 109 even when the BSSIDs (e.g., 172 and 174) are different. In other embodiments, the TDLS discovery request frame is sent immediately after associating with an AP. The TDLS discovery request frame may be sent at regular intervals, for instance, once per minute. The TDLS discovery request frame may be sent to a unicast address. A TDLS discovery request frame may be sent to a unicast address (AI=BSSID, A2=STA address, A3=unicast address). The unicast address to which a TDLS discovery request frame is transmitted may be obtained after a MAC Service Data Unit (MSDU) has been transmitted to or received from this address.

In other embodiments, the TDLS capability indication 118 or 119 is implied by receiving a TDLS discovery request frame 160 or response frame 162. A specific TDLS capability element (e.g., the capability element 134 or 136) may be included in the TDLS discovery request/response 112/116, including the encapsulated TDLS discovery request/response 160/162. For example, the TDLS capability may be signaled as part of an Extended Capability element that is included in the TDLS discovery request/response.

In other embodiments, information elements that are contained in the TDLS setup request/response frames are also contained in the TDLS discovery request/response frames. For the purpose of discovery, in one example, the TDLS setup rules are modified as follows: A TDLS setup request frame is transmitted to the Broadcast address, which designates the frame as a discovery frame (e.g., the transmitting of a TDLS setup request frame to a group address designates the setup request frame as a discovery frame). When receiving a broadcast TDLS setup request frame, a device that supports TDLS responds with a unicast TDLS setup response frame. In some embodiments, a TDLS setup confirmation frame may not be transmitted in response to a received TDLS setup response frame that responded to the broadcast TDLS setup request frame. Setup requests and corresponding responses can be matched using a dialog token (e.g., a token used to identify messages relating to the same dialog or message exchange). Reusing the TDLS setup frames for discovery eliminates the need to define new frames within the 802.11z protocol.

When the TDLS setup request frame is used for TDLS discovery, the start of a direct link may be initiated by sending a TDLS setup confirm frame (in which case the confirm frame is the only frame needed to start the direct link). Either STA (either requester or responder) may transmit a TDLS setup confirm frame in order to activate the TDLS direct link. However, a TDLS setup confirmation frame does not have to be transmitted between two TDLS-capable STAs after TDLS discovery, because the TDLS STAs may never actually exchange any data. In other embodiments, the state for all received broadcast TDLS setup requests and associated TDLS setup responses are stored at the STAs.

Accordingly, when the TDLS setup request and the TDLS setup response frames are used for discovery, it may be necessary to send another TDLS setup request frame (and possibly a corresponding TDLS setup response frame and a TDLS setup confirm frame) to actually set up a direct link. This reduces the burden of having to keep track of the capabilities of all STAs from which a received a TDLS setup request/response frame was received that was part of a TDLS discovery exchange.

In further embodiments, potential TDLS peer STAs can be discovered by sending a broadcast discovery request, wherein the discovery request information is encapsulated in a layer 2 (L2) encapsulation. Additionally, for example, in some embodiments, the discovery responses are sent to the unicast address of the requesting STA, wherein the discovery information is also encapsulated in the L2 encapsulation.

In some embodiments, the TDLS discovery frames may include one or more device type elements that indicate a primary and/or secondary purpose of the device. Examples of device types include, but are not limited to, computer, input device (e.g., mouse, keyboard, etc.), display, camera, smart-phone, etc. A TDLS discovery response may be transmitted only when a requested device type as present in the discovery request matches the device type at the receiving STA.

In some embodiments, the determination of which information elements are included in a TDLS Setup Request frame and a TDLS Setup Response frame may be by whether they are used for TDLS discovery or used for TDLS link setup. In some embodiments, for TDLS discovery, a Probe Request frame may be encapsulated in the TDLS Ethertype, and transmitted to the broadcast address or a unicast address. In addition to the regular information elements, the Probe Request may contain a Link Identifier, which specifies the MAC address of the transmitter STA and the BSSID. Other association parameters may be included also, such as the channel of the association, the current PHY rate from the AP, the type of security on the link with the AP, etc. The received Probe Responses will indicate whether the STA is TDLS capable through the Extended Capability element, or the TDLS capability may be inferred because the STA was able to parse the encapsulated Probe Request and respond with an encapsulated Probe Response. The Probe Response may contain a Link Identifier element that contains the TDLS initiator STA address, the BSSID of the TDLS responder STA, and the TDLS responder STA address. In some embodiments, the Probe Response is encapsulated in a TDLS frame. One skilled in the art would understand that the association parameters listed herein are not exclusive and that others not mentioned herein may be included without affecting the scope or spirit of the present disclosure.

With reference to FIGS. 1-11, in some embodiments, any of the illustrated stations STAs (e.g., STAs 102, 104, and/or 106) may be represented by station 2000. The station 2000 includes a processor 2001 for carrying out processing functions associated with one or more of components and functions described herein. The processor 2001 can include a single or multiple set of processors or multi-core processors. Moreover, the processor 2001 can be implemented as an integrated processing system and/or a distributed processing system.

The station 2000 further includes a memory 2002, such as for storing local versions of applications being executed by the processor 2001. The memory 2002 can include any type of memory usable by a computer, such as random access memory (RAM), read only memory (ROM), tapes, magnetic discs, optical discs, volatile memory, non-volatile memory, and any combination thereof.

Further, the station 2000 includes a communications component 2003 that provides for establishing and maintaining communications with one or more parties utilizing hard-ware, software, and services as described herein. The communications component 2003 may carry communications between components on the station 2000, as well as between the station 2000 and external devices, such as devices located across a communications network and/or devices serially or locally connected to the station 2000. For example, the communications component 2003 may include one or more buses, and may further include transmit chain components and receive chain components associated with a transmitter and receiver, respectively, operable for interfacing with external devices.

Additionally, the station 2000 may further include a data store 2004, which can be any suitable combination of hardware and/or software that provides for mass storage of information, databases, and programs employed in connection with aspects described herein. For example, the data store 2004 may be a data repository for applications not currently being executed by the processor 2001.

The station 2000 may additionally include a user interface component 2005 operable to receive inputs from a user of the station 2000, and further operable to generate outputs for presentation to the user. The user interface component 2005 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, the user interface component 2005 may include one or more output devices, including but not limited to a display, a speaker, a haptic feedback mechanism, a printer, any other mechanism capable of presenting an output to a user, or any combination thereof.

In some embodiments, the station 2000 may include the peer discovery component 108 configured to discover and initiate or establish a TDLS communication with another peer device, such as another station. The peer discovery component 108 includes all or some portion of the functionality described in the disclosure and/or the other various aspects described with regard to the various message flow diagrams and various implementations for generating such discovery requests and for determining such discovery responses discussed in the disclosure. Further examples of such are disclosed in (but are not limited to) U.S. patent application Ser. No. 12/917,382, which is herein incorporated by reference in its entirety.

In various embodiments, TDLS may be selected as the link method for wireless display (WFD), for instance, on a Wi-Fi display device. For instance, one of the STAs (e.g., 104) may be a source device for providing media (e.g., video data), to another of the STA (e.g., 106), which may a sink device. The media may be, for example (but is not limited to), video data (e.g., video clips), audio data, applications, games, internet browser, navigation applications, OS GUI (or other GUI), contact lists, etc. The source device 104 may be a mobile phone, PDA, laptop, tablet, media player, video game system, or any other device capable of playing and/or delivering media. The sink device 106 may be a display device, such as a television, monitor, DLP, automotive display, laptop, or the like, or any device capable of playing the delivered media. Accordingly, in various embodiments, media may be played on the source device 104 and mirrored and/or streamed on the sink device 106 via the TDLS link 109. In particular embodiments, the sink device 106 may a device for receiving the delivered media and then delivering the media to a display device (e.g., via a wired connection).

In such embodiments, after TDLS is established between the source device 104 and the sink device 106, the source device 104 and the sink device 106 might not know the IP address (local IP address) of each other, which may be necessary to establish the display session between the source device 104 and the sink device 106. This may occur, for instance, if no traffic is exchanged between the source device 104 and the sink device 106 before the TDLS is established. This may also occur, for instance, when it is not desirable to perform IP-based discovery over the WLAN via the AP (e.g., 102).

Accordingly, in various embodiments, a local IP address field may be provided in the vendor specific information element (IE) (e.g., 504, 604). In particular embodiments, the IE is unique to Wi-Fi display devices. In some embodiments, a TDLS-capable display device (e.g., the sink device 106) may include the IE having the local IP address field in the Probe Request frame 130 and/or the Probe Response frame 132. In particular embodiments, the local IP address field may be included based on qualifying conditions such as whether the device only prefers TDLS, whether the device is associated with the AP, and/or the like. In other embodiments, the IE having the local IP address field may be included in any suitable 802.11 management frames, such as Public Action frames, Action frames, and/or the like, which may be exchanged prior to establishing the display session.

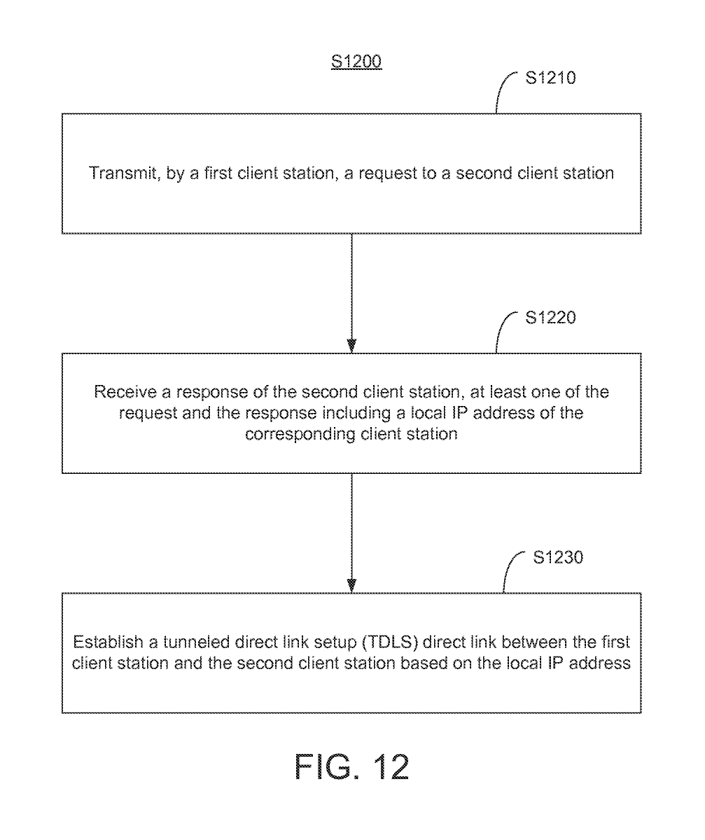

With reference to FIGS. 1-12, according to various embodiments a process S1200 includes transmitting, by a first client station (e.g., STA 104), a request to a second client station (e.g., STA 106) at block S1210. Then at block S1220, the process S1200 includes receiving a response of the second client station, at least one of the request and the response including a local IP address of the corresponding client station. At block S1230, the process S1200 includes establishing a tunneled direct link setup (TDLS) direct link between the first client station and the second client station based on the local IP address.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of peer discovery in a communications network, the method comprising:
transmitting, by a first client station, a request to a second client station;
receiving a response of the second client station, at least one of the request and the response including a local IP address of the corresponding client station; and
establishing a tunneled direct link setup (TDLS) direct link between the first client station and the second client station based on the local IP address.

2. The method of claim 1, wherein the request comprises a probe request.

3. The method of claim 1, wherein the response comprises a probe response.

4. The method of claim 1, wherein the request comprises a TDLS discovery request.

5. The method of claim 4, wherein the TDLS discovery request is sent via an access point.

6. The method of claim 4, wherein the TDLS discovery response is sent via an access point.

7. The method of claim 1, wherein the response comprises a TDLS discovery response.

8. The method of claim 1, wherein the request comprises a TDLS setup request.

9. The method of claim 8, wherein the TDLS setup request is sent via an access point.

10. The method of claim 8, wherein the TDLS setup response is sent via an access point.

11. The method of claim 1, wherein the response comprises a TDLS setup response.

12. The method of claim 1, wherein the first client station is a display device for displaying media content from the second client station via the TDLS direct link.

13. The method of claim 1, wherein the request comprises a probe request frame.

14. The method of claim 13, wherein the probe request frame includes a vendor specific information element in which the local IP address of the first client station is provided.

15. The method of claim 1, wherein the response comprises a probe response frame.

16. The method of claim 15, wherein the probe response frame includes a vendor specific information element in which the local IP address of the second client station is provided.

17. The method of claim 1, wherein the response is received from the access point.

18. The method of claim 1, wherein the response is received from the second client station.

19. The method of claim 1, wherein the local IP address is included only if the corresponding client station is associated with the access point.

20. The method of claim 1, wherein the local IP address is included only if the corresponding client station prefers using TDLS as the direct link.

21. The method of claim 1, wherein the first client station is a device tethered to a display device, the device for receiving media content from the second client station via the TDLS direct link and for causing the received media content to display on the display device.

22. The method of claim 1, wherein the second client station is a display device for displaying media content from the first client station via the TDLS direct link.

23. The method of claim 1, wherein the second client station is a device tethered to a display device, the device for receiving media content from the first client station via the TDLS direct link and for causing the received media content to display on the display device.

24. An apparatus for peer discovery in a communications network, the apparatus comprising:
means for transmitting, in a first client station, a request to a second client station;
means for receiving a response of the second client station, at least one of the request and the response including a local IP address of the corresponding client station; and
means for establishing a tunneled direct link setup (TDLS)direct link between the first client station and the second client station based on the local IP address.

25. The apparatus of claim 24, wherein the first client station is a display device for displaying media content from the second client station via the TDLS direct link.

26. The apparatus of claim 24, wherein the request comprises a probe request frame.

27. The apparatus of claim 26, wherein the probe request frame includes a vendor specific information element in which the local IP address of the first client station is provided.

28. The apparatus of claim 24, wherein the response comprises a probe response frame.

29. The apparatus of claim 28, wherein the probe response frame includes a vendor specific information element in which the local IP address of the second client station is provided.

30. The apparatus of claim 24, wherein the response is received from the access point.

31. The apparatus of claim 24, wherein the response is received from the second client station.

32. The apparatus of claim 24, wherein the local IP address is included only if the corresponding client station is associated with the access point.

33. The apparatus of claim 24, wherein the local IP address is included only if the corresponding client station prefers using TDLS as the direct link.

34. The apparatus of claim 24, wherein the first client station is a device tethered to a display device, the device for receiving media content from the second client station via the TDLS direct link and for causing the received media content to display on the display device.

35. The apparatus of claim 24, wherein the second client station is a display device for displaying media content from the first client station via the TDLS direct link.

36. The apparatus of claim 24, wherein the second client station is a device tethered to a display device, the device for receiving media content from the first client station via the TDLS direct link and for causing the received media content to display on the display device.

37. An apparatus for peer discovery in a communications network, the apparatus comprising:
a transmitter, in a first client station, for transmitting a request to a second client station;
a receiver for receiving a response of the second client station, at least one of the request and the response including a local IP address of the corresponding client station; and
the apparatus configured to establish a tunneled direct link setup (TDLS)direct link between the first client station and the second client station based on the local IP address.

38. The apparatus of claim 37, wherein the first client station is a display device for displaying media content from the second client station via the TDLS direct link.

39. The apparatus of claim 37, wherein the request comprises a probe request frame.

40. The apparatus of claim 39, wherein the probe request frame includes a vendor specific information element in which the local IP address of the first client station is provided.

41. The apparatus of claim 37, wherein the response comprises a probe response frame.

42. The apparatus of claim 41, wherein the probe response frame includes a vendor specific information element in which the local IP address of the second client station is provided.

43. The apparatus of claim 37, wherein the response is received from the access point.

44. The apparatus of claim 37, wherein the response is received from the second client station.

45. The apparatus of claim 37, wherein the local IP address is included only if the corresponding client station is associated with the access point.

46. The apparatus of claim 37, wherein the local IP address is included only if the corresponding client station prefers using TDLS as the direct link.

47. The apparatus of claim 37, wherein the first client station is a device tethered to a display device, the device for receiving media content from the second client station via the TDLS direct link and for causing the received media content to display on the display device.

48. The apparatus of claim 37, wherein the second client station is a display device for displaying media content from the first client station via the TDLS direct link.

49. The apparatus of claim 37, wherein the second client station is a device tethered to a display device, the device for receiving media content from the first client station via the TDLS direct link and for causing the received media content to display on the display device.

50. A computer program product for peer discovery, the computer program product comprising:
a computer-readable medium comprising code for:
transmitting, by a first client station, a request to a second client station;
receiving a response of the second client station, at least one of the request and the response including a local IP address of the corresponding client station; and
establishing a tunneled direct link setup (TDLS)direct link between the first client station and the second client station based on the local IP address.

51. The computer program product of claim 50, wherein the first client station is a display device for displaying media content from the second client station via the TDLS direct link.

52. The computer program product of claim 50, wherein the request comprises a probe request frame.

53. The computer program product of claim 52, wherein the probe request frame includes a vendor specific information element in which the local IP address of the first client station is provided.

54. The computer program product of claim 50, wherein the response comprises a probe response frame.

55. The computer program product of claim 54, wherein the probe response frame includes a vendor specific information element in which the local IP address of the second client station is provided.

56. The computer program product of claim 50, wherein the response is received from the access point.

57. The computer program product of claim 50, wherein the response is received from the second client station.

58. The computer program product of claim 50, wherein the local IP address is included only if the corresponding client station is associated with the access point.

59. The computer program product of claim 50, wherein the local IP address is included only if the corresponding client station prefers using TDLS as the direct link.

60. The computer program product of claim 50, wherein the first client station is a device tethered to a display device, the device for receiving media content from the second client station via the TDLS direct link and for causing the received media content to display on the display device.

61. A method of peer discovery in a communications network, the method comprising:
transmitting, by a first client station, a local IP address of the first client station; and
establishing a TDLS direct link between the first client station and a second client station based on the local IP address.
